(19) United States
(12) Patent Application Publication
(10) Pub. No.: US 2024/0151330 A1
(43) Pub. Date: May 9, 2024

(54) MULTILAYERED TUBULAR SHAPED OBJECT

(71) Applicant: TOYOX CO., LTD., Toyama (JP)

(72) Inventors: Daichi AOKI, Toyama (JP); Kenichi NUMATA, Toyama (JP)

(21) Appl. No.: 18/411,980

(22) Filed: Jan. 12, 2024

Related U.S. Application Data
(63) Continuation of application No. PCT/JP2022/026165, filed on Jun. 30, 2022.

(30) Foreign Application Priority Data
Jul. 20, 2021 (JP) 2021-119225

(51) Int. Cl. F16L 11/08

(52) U.S. Cl. CPC F16L 11/081

(57) ABSTRACT

A multilayered tubular shaped object has an inner layer, an outer layer, and an interlayer interposed between the inner layer and the outer layer to bond them together, and the inner layer contains a polyolefin as a main component, the outer layer contains a thermoplastic polyurethane as a main component, the interlayer contains an adhesive polyolefin as a main component, a thickness of the outer layer is 1 to 1.5 mm, and a proportion of a sum of the thickness of the outer layer and a thickness of the interlayer to a thickness of the multilayered tubular shaped object is 0.7 to 0.88, and a softening temperature of the thermoplastic polyurethane is 135 to 200° C.

### CROSS-REFERENCE TO RELATED APPLICATION

This patent application is a bypass continuation of PCT Application No. PCT/JP2022/026165 filed on Jun. 30, 2022 which claims the benefit of priority under 35 USC 119 to Japanese Patent Application NO. 2021-119225 filed Jul. 20, 2021, the entire contents of both of which are incorporated herein by reference for all purposes.

### BACKGROUND

### Technical Field

The present disclosure relates to a multilayered tubular shaped object.

### Description of the Related Art

Polyolefins have excellent heat resistance, transparency and water repellency and are difficult to smell and be colored, but have poor flexibility and brittleness properties. Therefore, when a thick-walled tubular shaped object is formed using a polyolefin, flexibility is lost and the object is easily broken, and even when a thin-walled tubular shaped object is formed, it is still easily broken.

Polyurethanes on the other hand have excellent heat resistance, flexibility and transparency, but easily smells and are colored, and has poor water repellency.

Therefore, when a multilayered tubular shaped object is produced by combining a polyolefin and a polyurethane, the properties of being difficult to smell and be colored and excellent water repellency of the polyolefin and excellent flexibility of the polyurethane can be provided for the object.

This multilayered tubular shaped object can have a heat resistant temperature (80 to 100° C.) in the intermediate region between tubular shaped objects made of soft vinyl chloride (heat resistant temperature: 70° C.) and tubular shaped objects made of silicone rubber (heat resistant temperature: 150° C.). Therefore, the multilayered tubular shaped object is separated from the tubular shaped objects made of soft vinyl chloride and the tubular shaped objects made of silicone rubber concerning performance and costs, for example, in food and cosmetics industries, and can be applied to desired uses and environments (which is, for example, arranged as a pipe, and incorporated into a machine).

Japanese Unexamined Patent Application Publication No. 2008-132659, for example, discloses a multilayered tube (multilayered tubular shaped object) having an inner layer including a polyolefin resin, an outer layer including a polyurethane resin, and an interlayer including an adhesive polyolefin resin between the inner layer and the outer layer.

### SUMMARY

According to an aspect of the present disclosure, there is provided a multilayered tubular shaped object, having an inner layer, an outer layer, and an interlayer interposed between the inner layer and the outer layer to bond them together, wherein the inner layer contains a polyolefin as a main component, the outer layer contains a thermoplastic polyurethane as a main component, the interlayer contains an adhesive polyolefin as a main component, a thickness of the outer layer is 1 to 1.5 mm, a proportion of a sum of the thickness of the outer layer and a thickness of the interlayer to a thickness of the multilayered tubular shaped object is 0.7 to 0.88, and a softening temperature of the thermoplastic polyurethane is 135 to 200° C.

### BRIEF DESCRIPTION OF THE DRAWINGS

FIG. 1 is a perspective view showing an embodiment of a partially cut multilayered tubular shaped object of the present disclosure.

FIG. 2 is a cross-sectional view taken along the A-A line in FIG. 1.

FIG. 3 is a perspective view showing a partially cut structure of a pressure resistant hose.

FIG. 4 is a drawing illustrating a compression bending test method.

FIG. 5 is a drawing illustrating a test method for measuring the amount of deflection.

### DESCRIPTION OF THE EMBODIMENT

First, the issues of the above-described Japanese Unexamined Patent Application Publication No. 2008-132659 First are discussed. It is described that the multilayered tube in Patent Literature 1 has excellent flexibility. However, a problem due to temperature dependence is not described. According to investigations of the present inventors, it was clarified that wrinkles were generated on the inner surface depending on the temperature of a fluid which is allowed to pass through the tube and the thickness of the inner layer, and the multilayered tube could not be used at a temperature in the intermediate region.

According to investigations of the present inventors, it was also clarified that wrinkles were easily generated on the inner surface even at room temperature depending on the degree in which the multilayered tube is bent.

An object of the present disclosure is to provide a multilayered tubular shaped object, having high flexibility and being less prone to wrinkles on the inner surface.

The object as described above is achieved by the present disclosure in (1) to (20) below.

(1) A multilayered tubular shaped object, having an inner layer, an outer layer, and an interlayer interposed between the inner layer and the outer layer to bond them together, wherein the inner layer contains a polyolefin as a main component, the outer layer contains a thermoplastic polyurethane as a main component, the interlayer contains an adhesive polyolefin as a main component, and the proportion of the sum of the thickness of the outer layer and the thickness of the interlayer to the thickness of the multilayered tubular shaped object is 0.7 to 0.92.

(2) The multilayered tubular shaped object according to (1) above, wherein the proportion of the thickness of the interlayer to the thickness of the inner layer is 0.1 or more and less than 2.

(3) The multilayered tubular shaped object according to (1) or (2) above, wherein the proportion of the thickness of the inner layer to the thickness of the multilayered tubular shaped object is 0.06 to 0.25.

(4) The multilayered tubular shaped object according to any one of (1) to (3) above, wherein the amount of the polyolefin contained in the inner layer is 75 mass % or more.

(5) The multilayered tubular shaped object according to any one of (1) to (4) above, wherein the softening temperature of the polyolefin is 95 to 190° C.

(6) The multilayered tubular shaped object according to any one of (1) to (5) above, wherein the polyolefin includes at least one of polyethylene, syndiotactic polypropylene, isotactic polypropylene and polymethyl pentene.

(7) The multilayered tubular shaped object according to any one of (1) to (6) above, wherein the thickness of the inner layer is 0.05 to 2.5 mm.

(8) The multilayered tubular shaped object according to any one of (1) to (7) above, wherein the amount of the thermoplastic polyurethane contained in the outer layer is 75 weight % or more.

(9) The multilayered tubular shaped object according to any one of (1) to (8) above, wherein the softening temperature of the thermoplastic polyurethane is 135 to 200° C.

(10) The multilayered tubular shaped object according to any one of (1) to (9) above, wherein the thermoplastic polyurethane includes at least one of an adipate ester-based thermoplastic polyurethane, an ether-based thermoplastic polyurethane, a caprolactone-based thermoplastic polyurethane and a polycarbonate-based thermoplastic polyurethane.

(11) The multilayered tubular shaped object according to any one of (1) to (10) above, wherein the thickness of the outer layer is 0.5 to 2.5 mm.

(12) The multilayered tubular shaped object according to any one of (1) to (11) above, wherein the amount of the adhesive polyolefin contained in the interlayer is 75 mass % or more.

(13) The multilayered tubular shaped object according to any one of (1) to (12) above, wherein the softening temperature of the adhesive polyolefin is 120 to 185° C.

(14) The multilayered tubular shaped object according to anyone of (1) to (13) above, wherein the adhesive polyolefin includes a polyolefin having an aromatic ring on a side chain.

(15) The multilayered tubular shaped object according to (14) above, wherein the adhesive polyolefin includes a styrene grafted polyolefin and polystyrene.

(16) The multilayered tubular shaped object according to anyone of (1) to (13) above, wherein the adhesive polyolefin includes an ester containing group on a side chain.

(17) The multilayered tubular shaped object according to (16) above, wherein the adhesive polyolefin includes a maleic anhydride modified ethylene-vinyl acetate copolymer.

(18) The multilayered tubular shaped object according to any one of (1) to (17) above, wherein the thickness of the interlayer is 0.01 to 1.5 mm.

(19) The multilayered tubular shaped object according to any one of (1) to (18) above, wherein the maximum load in a compression bending test (span: 200 mm) for the multilayered tubular shaped object is 19 N or less.

(20) The multilayered tubular shaped object according to any one of (1) to (19) above, wherein the amount of deflection of the multilayered tubular shaped object is less than 40 mm in a test for measuring the amount of deflection (temperature: 100° C.).

According to the present disclosure, it is possible to obtain a multilayered tubular shaped object, having high flexibility and being less prone to wrinkles on the inner surface.

The multilayered tubular shaped object of the present disclosure will now be described in detail based on suitable embodiments shown in the appended drawings.

<Multilayered Tubular Shaped Object>

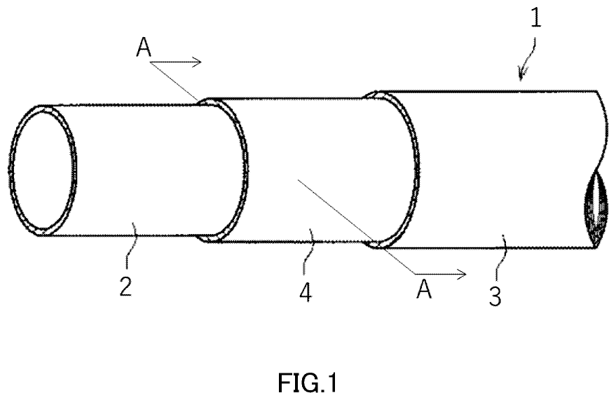

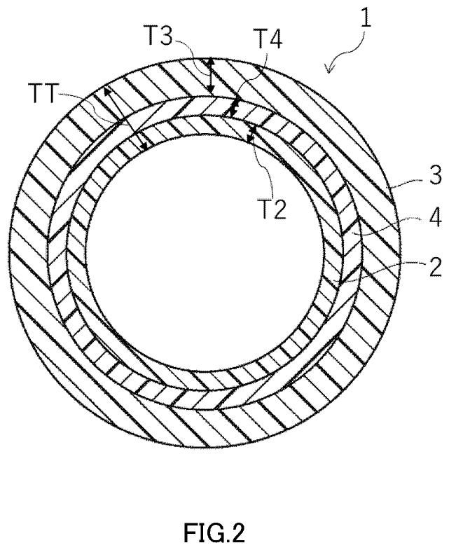

FIG. 1 is a perspective view showing an embodiment of a partially cut multilayered tubular shaped object of the present disclosure, and FIG. 2 is a cross-sectional view taken along the A-A line in FIG. 1.

The multilayered tubular shaped object 1 shown in FIG. 1 has an inner layer 2, an outer layer 3, and an interlayer 4 interposed between the inner layer 2 and the outer layer 3.

The structures of the layers will now be described in turn.

<<Inner Layer 2>>

The inner layer 2 is a layer containing a polyolefin as a main component. Polyolefins have excellent heat resistance, transparency and water repellency, and are difficult to smell and be colored. Therefore, by providing the inner layer 2 containing a polyolefin as a main component, excellent properties based on these properties can be provided for the multilayered tubular shaped object 1.

Examples of the polyolefin include polyethylene such as low density polyethylene (LDPE), linear low density polyethylene (LLDPE), very low density polyethylene (VLDPE), medium density polyethylene (MDPE), high density polyethylene (HDPE) and very high density polyethylene (VHDPE), polypropylene such as isotactic polypropylene and syndiotactic polypropylene, polybutene, a copolymer of ethylene and an α-olefin, polymethyl pentene and the like. These can be used individually or two or more of these can be used in combination.

Among these, the polyolefin includes preferably at least one selected from the group consisting of polyethylene, polypropylene and polymethyl pentene, and more preferably at least one selected from the group consisting of LDPE, LLDPE, VLDPE, HDPE, VHDPE, isotactic polypropylene, syndiotactic polypropylene and polymethyl pentene, further preferably at least one of HDPE, syndiotactic polypropylene, isotactic polypropylene and polymethyl pentene, and particularly preferably polypropylene. The heat resistance of the inner layer 2 is more easily improved by using these polyolefins.

The softening temperature of the polyolefin is preferably about 95 to 190° C., and more preferably about 105 to 170° C. By using a polyolefin having the softening temperature as described above, a heat resistance temperature (80° C. to 100° C.) in the intermediate region between the tubular shaped objects made of soft polyvinyl chloride (heat resistance temperature: 70° C.) and the tubular shaped objects made of silicone rubber (heat resistance temperature: 150° C.) can be provided for the multilayered tubular shaped object 1.

It should be noted that the softening temperature can be measured by dynamic mechanical analysis (DMA) method.

The amount of the polyolefin contained in the inner layer 2 is preferably 75 mass % or more, and more preferably 85 mass % or more and further preferably 95 mass % or more, and may be also 100 mass %. In this case, the properties based on the polyolefin can be sufficiently provided for the inner layer 2.

<<Outer Layer 3>>

The outer layer 3 is a layer containing a thermoplastic polyurethane (TPU) as a main component. TPU has excellent heat resistance, flexibility and transparency. Herein, in the inner layer 2 containing a polyolefin as a main component, flexibility (pliability) easily becomes low; however, high flexibility (pliability) can be secured as the whole multilayered tubular shaped object 1 by combining the inner layer 2 with the outer layer 3 containing TPU as a main component.

Examples of TPU include an adipate ester-based TPU, an ether-based TPU, a caprolactone-based TPU, a polycarbonate-based TPU and the like. These can be used individually or two or more of these can be used in combination.

It should be noted that the adipate ester-based TPU is a general grade TPU, the ether-based TPU is TPU at a grade with excellent hydrolysis resistance and fungus resistance, the caprolactone-based TPU is TPU at a grade with excellent injection moldability, and the polycarbonate-based TPU is TPU at a grade with excellent hydrolyzability, fungus resistance and heat resistance.

It is preferable for the softening temperature of TPU to be about 135 to 200° C., and more preferably about 155 to 190° C. By using TPU having the softening temperature as described above, changes in quality and deterioration of the outer layer 3 can be suitably prevented or suppressed even when a fluid with a temperature of 80° C. to 100° C. is allowed to pass through the multilayered tubular shaped object 1.

The weight average molecular weight of TPU is preferably about 40,000 to 200,000, and more preferably about 80,000 to 160,000.

It should be noted that various other polymers and additives mentioned in the inner layer 2 may be added to TPU without losing the properties of the outer layer 3.

The amount of TPU contained in the outer layer 3 is preferably 75 mass % or more, and more preferably 85 mass % or more and further preferably 95 mass % or more, and may be also 100 mass %. In this case, the properties based on TPU can be sufficiently provided for the inner layer 2.

The interlayer 4 containing an adhesive polyolefin as a main component is interposed between the inner layer 2 and the outer layer 3. This interlayer 4 includes a function of bonding the inner layer 2 and the outer layer 3. It should be noted that the main function of the interlayer 4 is the adhesion function; however, the interlayer 4 may further display other functions such as a cushioning function, a kink resistance function, a gas permeation suppressing function, a UV cut function and a heat resistance improving function.

The adhesive polyolefin preferably includes one of a first polyolefin having an aromatic ring on a side chain and a second polyolefin having an ester containing group on a side chain.

In the aromatic ring in the first polyolefin, the electron bias is large due to the existence of the main chain (aliphatic hydrocarbon chain), and a part having a low electron density (positively charged part) exists. On the other hand, the urethane bond in TPU has a negatively charged part due to polarization. Therefore, the urethan bond in TPU is strongly attracted to the aromatic ring in the first polyolefin, which is stable by the action of the van der Waals force. That is, it is thought that the outer layer 3 and the interlayer 4 are bonded to each other by high interaction between the first polyolefin and TPU.

The ester containing group in the second polyolefin includes a C═O bond and a C—O bond (or a C—O—C bond) next to each other. The C═O bond has a higher electron density than that of the C—O bond, and the urethan bond in TPU is strongly attracted thereto, which is stable by the action of the van der Waals force. That is, it is thought that the outer layer 3 and the interlayer 4 are bonded to each other by high interaction between the second polyolefin and TPU.

Meanwhile both the first polyolefin and the second polyolefin include a saturated hydrocarbon structure (polyolefin) on the main chain thereof, and thus have a high affinity for the polyolefin in the inner layer 2. That is, it is thought that the inner layer 2 and the interlayer 4 are bonded to each other by high interaction between the first polyolefin or the second polyolefin and the polyolefin in the inner layer 2.

Examples of the aromatic ring in the first polyolefin include a benzene ring, a naphthalene ring, an anthracene ring, a pyridine ring, a furan ring and the like. Among these, the benzene ring is preferred from the viewpoint of suppressing a reduction in the affinity for the polyolefin in the inner layer 2.

Examples of the first polyolefin include a styrene grafted polyolefin, polystyrene and the like.

In particular, the first polyolefin preferably includes a styrene grafted polyolefin and polystyrene. The first polyolefin as described above can more highly interact with TPU. In this case, the first polyolefin may be a mixture (polymer alloy, etc.) of a styrene grafted polyolefin and polystyrene, or may have a core/shell structure having a polystyrene core and a styrene grafted polyolefin shell.

Examples of the ester containing group in the second polyolefin include an alkyl ester group, an aryl ester group, a maleic anhydride group, a succinic anhydride group, a phthalic anhydride group and the like.

Examples of the second polyolefin include a maleic anhydride modified ethylene-vinyl acetate copolymer, a maleic anhydride modified polyvinyl alcohol and the like. In particular, the second polyolefin preferably includes a maleic anhydride modified ethylene-vinyl acetate copolymer. The second polyolefin as described above can more highly interact with the polyolefin in the inner layer 2.

The amount of maleic anhydride added or grafted to an ethylene-vinyl acetate copolymer is preferably about 0.0001 to 15 parts by mass with respect to 100 parts by mass of an ethylene-vinyl acetate copolymer, and more preferably about 0.001 to 10 parts by mass.

The softening temperature of the adhesive polyolefin is preferably about 120 to 185° C., and more preferably about 140 to 165° C. By using the adhesive polyolefin with the softening temperature as described above, changes in quality of the interlayer 4 can be suppressed to prevent peeling between the inner layer 2 and the outer layer 3 even when a fluid with a temperature of 80° C. to 100° C. is allowed to pass through the multilayered tubular shaped object 1.

The weight average molecular weight of the adhesive polyolefin is preferably about 40,000 to 200,000, and more preferably about 80,000 to 160,000.

Various tackifiers (adhesion enhancing agents) may be added to the adhesive polyolefin from the viewpoint of increasing the viscosity and adhesive properties of the interlayer 4.

Examples of the tackifiers include rosin-based, rosin derivative-based, terpene resin-based and terpene derivative-based natural tackifiers, petroleum resin-based, styrene resin-based, coumarone indene resin-based, phenol resin-based and xylene resin-based synthetic tackifiers and the like.

Various other polymers and additives mentioned in the inner layer 2 may be also added to the adhesive polyolefin without losing the properties of the interlayer 4.

The amount of the adhesive polyolefin contained in the interlayer 4 is preferably 75 mass % or more, and more preferably 85 mass % or more and further preferably 95 mass % or more, and may be also 100 mass %. In this case, the properties based on the adhesive polyolefin can be sufficiently provided for the interlayer 4.

The present disclosure is characterized by properly setting the thickness of the inner layer 2, the thickness of the outer layer 3, the thickness of the interlayer 4, and the relationships of these. This will now be described.

The proportion of the sum of the thickness T3 [mm] of the outer layer 3 and the thickness T4 [mm] of the interlayer 4 to the thickness TT [mm] of the multilayered tubular shaped object 1 ([T3+T4]/TT) is 0.7 to 0.92. Consequently, it is possible to obtain a multilayered tubular shaped object 1 having high flexibility and being less prone to wrinkles on the inner surface.

When a multilayered tubular shaped object having poor flexibility is forced to be deformed and is arranged as a pipe, the object is broken, cracks are generated, and delivery losses are caused. Peeling is also caused between the inner layer and the outer layer, and thus a fluid enters the interlayer, leading to discoloration and proliferation of germs. Meanwhile, when wrinkles are generated on the inner surface of the multilayered tubular shaped object 1 (hereinafter simply referred to as “inner surface”), the inner surface does not become smooth, and thus the rest of a fluid easily remains, still leading to proliferation of germs.

[T3+T4]/TT is preferably about 0.75 to 0.9, and more preferably 0.8 to 0.88. Consequently, the above effect can be further improved.

The proportion of the thickness T4 of the interlayer 4 to the thickness T2 [mm] of the inner layer 2 (T4/T2) is not particularly limited, and is preferably 0.1 or more and less than 2, and more preferably about 0.3 to 1.7 and further preferably about 0.5 to 1.5. Consequently, peeling between the inner layer 2 and the outer layer 3 can be prevented, and generation of wrinkles on the inner surface can be also certainly prevented.

The proportion of the thickness T2 of the inner layer 2 to the thickness TT of the multilayered tubular shaped object 1 (T2/TT) is also not particularly limited, and is preferably about 0.06 to 0.25, and more preferably about 0.08 to 0.23 and further preferably about 0.1 to 0.2. Consequently, an increase in the thickness T2 of the inner layer 2 is prevented and generation of wrinkles on the inner surface can be prevented.

A specific value of the thickness T2 of the inner layer 2 is not particularly limited, and is preferably about 0.05 to 2.5 mm, and more preferably about 0.1 to 2 mm.

Consequently, this allows for the prevention of reduced flexibility in the multilayered tubular shaped object 1, while making it less likely for wrinkles to form in the inner layer 2.

A specific value of the thickness T3 of the outer layer 3 is also not particularly limited, and is preferably about 0.5 to 2.5 mm, and more preferably about 0.75 to 2 mm and further preferably about 1 to 1.5 mm. Consequently, the flexibility of the multilayered tubular shaped object 1 can be sufficiently increased.

A specific value of the thickness T4 of the interlayer 4 is also not particularly limited, and is preferably about 0.01 to 1.5 mm, and more preferably about 0.05 to 1 mm and further preferably about 0.1 to 0.5 mm. Consequently, the thickness of the multilayered tubular shaped object 1 is prevented from becoming thicker than required, and also high adhesive properties to the inner layer 2 and the outer layer 3 can be maintained.

In the multilayered tubular shaped object 1, the maximum load in a compression bending test (span: 200 mm) is preferably 19 N or less, and more preferably 17 N or less and further preferably 14.6 N or less. It can be concluded that the multilayered tubular shaped object 1 meeting the value as described above has high flexibility. It should be noted that the lower limit of the maximum load is normally about 13 N.

In addition, the amount of deflection is preferably less than 40 mm, and more preferably less than 38 mm and further preferably less than 36 mm in a test for measuring the amount of deflection (temperature: 100° C.). It can be concluded that in the multilayered tubular shaped object 1 meeting the value as described above, temperature dependence is low, and wrinkles are less likely to be generated in the inner layer 2. It should be noted that the lower limit of the amount of deflection is normally about 30 mm.

The multilayered tubular shaped object 1 as described above is preferably an integrated object formed by the co-extrusion molding of the inner layer 2, the interlayer 4 and the outer layer 3. In the multilayered tubular shaped object 1, adhesive properties between the inner layer 2 and the outer layer 3 and the interlayer 4 are more easily improved.

In addition, when using a polyolefin, a thermoplastic polyurethane and an adhesive polyolefin having the softening temperatures in the above ranges, the softening temperatures are close to each other, and thus stable and continuous co-extrusion molding can be carried out.

In the multilayered tubular shaped object 1 as described above, flexibility is sufficient, wrinkles are less likely to be generated on the inner surface, and chemical resistance and heat resistance are also excellent. Therefore, the multilayered tubular shaped object 1 is suitably used in the fields of, for example, food processing, cosmetics production, chemicals production, etc.

The multilayered tubular shaped object of the present disclosure can be used, for example, as a tube, a hose, etc.

The multilayered tubular shaped object of the present disclosure can be also used as a pressure resistant hose by providing a reinforcement layer including, for example, a reinforcement wire rod and an outermost layer as needed.

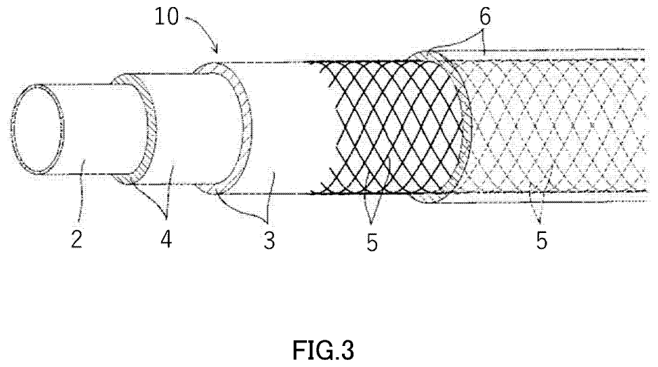

An example of the pressure resistant hose is shown in FIG. 3. FIG. 3 is a perspective view showing a partially cut structure of a pressure resistant hose.

The pressure resistant hose 10 shown in FIG. 3 has a structure which includes the inner layer 2, the outer layer 3 and the interlayer 4, and further includes the reinforcement layer 5 and the outermost layer 6 outside the outer layer 3 in this order.

Examples of the reinforcement wire rod to form the reinforcement layer 5 include a plurality of or single braid including, e.g., polyester, nylon (registered trademark) or an aramid fiber, a multifilament obtained by braiding thin monofilaments (single fibers), a monofilament including, e.g., an olefin resin or a polyester resin, flat yarn (or tape yarn) including tape-shaped yarn, metal wire including, e.g., stainless, or a coil including a hard material similar to stainless, and the like.

The reinforcement wire rod as described above is preferably wound along the outer layer 3 in a spiral shape to form a net, or knitted along the outer layer 3 to be woven into a hollow cylindrical net. Consequently, the physical properties such as pressure resistance performance and shape retention performance of the pressure resistant hose 10 can be improved.

In addition, a resin material having good adhesion to the outer layer 3 is preferably used as a constituent material for the outermost layer 6.

The multilayered tubular shaped object of the present disclosure has been described above. It should be noted, however, that the present disclosure is not limited to the structures of the embodiments described above.

In the multilayered tubular shaped object of the present disclosure, any structure may be added to the structures in the above-described embodiments, or the structures in the above-described embodiments may be replaced with any structure displaying the same function.

### EXAMPLES

The present disclosure will now be described in detail byway of example. It should be noted, however, that the present disclosure is not limited thereto.

1. Preparation of Layer Forming Materials

1-1. Inner Layer Forming Material

An inner layer forming material containing 100 mass % of syndiotactic polypropylene (“WELNEX RMG02” manufactured by Japan Polypropylene Corporation) was prepared. It should be noted that the softening temperature of the polypropylene was 115° C.

1-2. Outer Layer Forming Material

<Outer Layer Forming Material 1>

An outer layer forming material containing 100 mass % of a thermoplastic polyurethane (“RESAMINE PH890” manufactured by Dainichiseika Color & Chemicals Mfg. Co.) was prepared. It should be noted that the weight average molecular weight of the thermoplastic polyurethane was 500 to 3,000, and the softening temperature thereof was 183° C.

<Outer Layer Forming Material 2>

An outer layer forming material containing 100 mass % of a high strength urethane rubber (“VULKOLLAN” manufactured by Bayer AG) was prepared.

1-3. Interlayer Forming Material

<Interlayer Forming Material 1>

An interlayer forming material containing 100 mass % of an adhesive polyolefin (“MODIC GK110” manufactured by Mitsubishi Chemical Group Corporation) was prepared. It should be noted that the weight average molecular weight of the adhesive polyolefin was 5,000 to 110,000, and the softening temperature thereof was 155° C. or lower.

<Interlayer Forming Material 2>

An interlayer forming material containing 100 mass % of an adhesive polyolefin (“ADMER NF528” manufactured by Mitsui Chemicals, Inc.) was prepared. It should be noted that the weight average molecular weight of the adhesive polyolefin was 50,000 to 110,000, and the softening temperature thereof was 155° C. or lower.

2. Production of Multilayered Tubular Shaped Object

### Example 1

The inner layer forming material, the interlayer forming material 1 and the outer layer forming material 1 were melted and co-extruded using a three layer extruder to produce a multilayered tubular shaped object having a three layer structure.

It should be noted that the thickness of the inner layer was 0.2 mm, the thickness of the interlayer was 0.1 mm, the thickness of the outer layer was 1.3 mm, and the inner diameter was 15 mm, and the outer diameter was 18.2 mm.

### Example 2

A multilayered tubular shaped object was produced in the same manner as in Example 1 except that the thickness of the inner layer was changed to 0.3 mm, the thickness of the interlayer was changed to 0.3 mm, and the thickness of the outer layer was changed to 1.0 mm.

### Example 3

A multilayered tubular shaped object was produced in the same manner as in Example 1 except that the thickness of the inner layer was changed to 0.3 mm, the thickness of the interlayer was changed to 0.1 mm, and the thickness of the outer layer was changed to 1.2 mm.

### Example 4

A multilayered tubular shaped object was produced in the same manner as in Example 1 except that the interlayer forming material 2 was used in place of the interlayer forming material 1.

### Comparative Example 1

A multilayered tubular shaped object was produced in the same manner as in Example 1 except that the thickness of the inner layer was changed to 0.1 mm, the thickness of the interlayer was changed to 0.1 mm, and the thickness of the outer layer was changed to 1.4 mm.

### Comparative Example 2

A multilayered tubular shaped object was produced in the same manner as in Example 1 except that the thickness of the inner layer was changed to 0.1 mm, the thickness of the interlayer was changed to 0.3 mm, and the thickness of the outer layer was changed to 1.2 mm.

### Comparative Example 3

A multilayered tubular shaped object was produced in the same manner as in Example 1 except that the thickness of the inner layer was changed to 0.1 mm, the thickness of the interlayer was changed to 0.2 mm, and the thickness of the outer layer was changed to 1.3 mm.

### Comparative Example 4

A multilayered tubular shaped object was produced in the same manner as in Example 1 except that the outer layer forming material 2 was used in place of the outer layer forming material 1.

3. Evaluation

3-1. Flexibility

The maximum load in a compression bending test (span: 200 mm) for the multilayered tubular shaped objects obtained in Examples and Comparative Examples was measured.

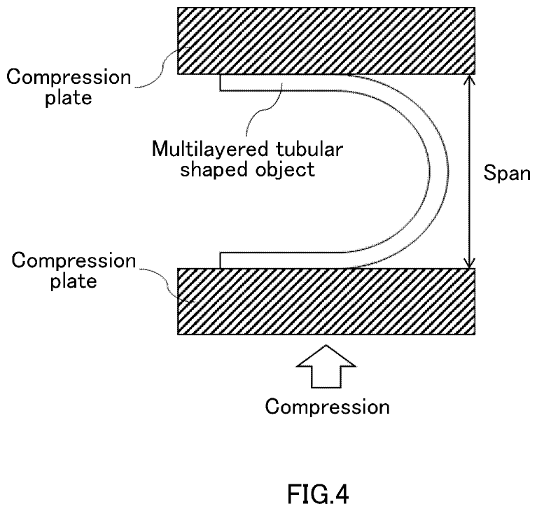

It should be noted that the compression bending test was carried out as shown in FIG. 4.

Specifically, a multilayered tubular shaped object obtained in each Example and Comparative Example was put between a pair of compression plates and curved into a U shape at a compression velocity of 200 mm/min, and when the span reached 200 mm, the maximum load was measured. It should be noted that the total length of the multilayered tubular shaped object was 400 mm.

Flexibility was evaluated using the measured maximum load in accordance with the following evaluation criteria:
oo: the maximum load is 14.6 N or less,
o: the maximum load is above 14.6 N and 19.0 N or less, and
x: the maximum load is above 19.0 N.

That is, the smaller the maximum load (N) is, the more it can be determined that the multilayered tubular shaped object excels in flexibility.

3-2. Susceptibility to Wrinkles Caused by Heat

The amount of deflection of the multilayered tubular shaped objects obtained in Examples and Comparative Examples was measured in a test for measuring the amount of deflection (temperature: 100° C.)

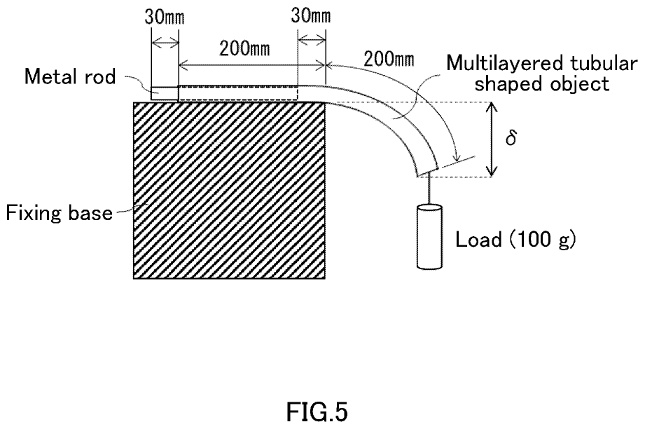

It should be noted that the test for measuring the amount of deflection was carried out as shown in FIG. 5.

Specifically, a multilayered tubular shaped object obtained in each Example and Comparative Example was prepared and retained at 100° C. for 30 minutes. Subsequently, a metal rod with a length of 200 mm was fixed in a state in which it was inserted so that a 30 mm portion thereof was projected from the multilayered tubular shaped object. It should be noted that the total length of the multilayered tubular shaped object was 400 mm.

Then as shown in FIG. 5, the 30 mm projected portion of the metal rod was fixed on a fixing base in a state in which a 200 mm portion was projected into the air. Subsequently, a load (100 g) was added to the end of the portion projected into the air for a minute, and the amount of deflection (δ) was measured.

The susceptibility to wrinkles caused by heat was evaluated using the measured amount of deflection in accordance with the following evaluation criteria.

[Evaluation Criteria]
oo: The amount of deflection is less than 36 mm,
o: the amount of deflection is 36 mm or more and less than 40 mm, and
x: the amount of deflection is 40 mm or more.

That is, the greater the amount of deflection (mm), the higher the temperature dependence, and it can be determined that wrinkles are more likely to occur on the inner surface of the multilayered tubular shaped object.

These evaluation results are shown in Table 1 below.

TABLE 1

| | Multilayered tubular shaped object | | | | | | | | |
|---|---|---|---|---|---|---|---|---|---|
| | Thickness of layer [mm] | | | Total | Proportion | | | | |
| | Interlayer | Interlayer | Outerlayer | thickness | (T3 + | T4/ | T2/ | Evaluation | |
| | T2 | T4 | T3 | TT [mm] | T4)/TT | T2 | TT | Flexibility | Wrinkle |
| Example 1 | 0.2 | 0.1 | 1.3 | 1.6 | 0.88 | 0.5 | 0.13 | ◯◯ | ○○ |
| Example 2 | 0.3 | 0.3 | 1.0 | 1.6 | 0.81 | 1.0 | 0.19 | ◯ | ○○ |
| Example 3 | 0.3 | 0.1 | 1.2 | 1.6 | 0.81 | 0.3 | 0.19 | ◯ | ○○ |
| Example 4 | 0.2 | 0.1 | 1.3 | 1.6 | 0.88 | 0.5 | 0.13 | ◯◯ | ○○ |
| Comparative | 0.1 | 0.1 | 1.4 | 1.6 | 0.94 | 1.0 | 0.07 | ◯ | x |
| Example 1 | | | | | | | | | |
| Comparative | 0.1 | 0.3 | 1.2 | 1.6 | 0.94 | 3.0 | 0.07 | ◯◯ | x |
| Example 2 | | | | | | | | | |
| Comparative | 0.1 | 0.2 | 1.3 | 1.6 | 0.94 | 2.0 | 0.07 | ◯ | x |
| Example 3 | | | | | | | | | |
| Comparative | 0.2 | 0.1 | 1.3 | 1.6 | 0.88 | 0.5 | 0.13 | X | ○ |
| Example 4 | | | | | | | | | |

As shown in Table 1, the multilayered tubular shaped objects obtained in each Example were confirmed to have high flexibility and were less prone to wrinkles on the inner surface.

In contrast, the multilayered tubular shaped objects obtained in each Comparative Example were confirmed to be either less flexible or more prone to wrinkles on the inner surface.

What is claimed is:

1. A multilayered tubular shaped object, having an inner layer, an outer layer, and an interlayer interposed between the inner layer and the outer layer to bond them together, wherein:
the inner layer contains a polyolefin as a main component,
the outer layer contains a thermoplastic polyurethane as a main component,
the interlayer contains an adhesive polyolefin as a main component,
a thickness of the outer layer is 1 to 1.5 mm,
a proportion of a sum of the thickness of the outer layer and a thickness of the interlayer to a thickness of the multilayered tubular shaped object is 0.7 to 0.88, and
a softening temperature of the thermoplastic polyurethane is 135 to 200° C.

2. The multilayered tubular shaped object according to claim 1, wherein a proportion of the thickness of the interlayer to a thickness of the inner layer is 0.1 or more and less than 2.

3. The multilayered tubular shaped object according to claim 1, wherein a proportion of the thickness of the inner layer to the thickness of the multilayered tubular shaped object is 0.06 to 0.25.

4. The multilayered tubular shaped object according to claim 1, wherein an amount of the polyolefin contained in the inner layer is 75 mass % or more.

5. The multilayered tubular shaped object according to claim 1, wherein a softening temperature of the polyolefin is 95 to 190° C.

6. The multilayered tubular shaped object according to claim 1, wherein the polyolefin comprises at least one of high density polyethylene, syndiotactic polypropylene, isotactic polypropylene and polymethyl pentene.

7. The multilayered tubular shaped object according to claim 1, wherein the thickness of the inner layer is 0.05 to 2.5 mm.

8. The multilayered tubular shaped object according to claim 1, wherein an amount of the thermoplastic polyurethane contained in the outer layer is 75 weight % or more.

9. The multilayered tubular shaped object according to claim 1, wherein the thermoplastic polyurethane comprises at least one of an adipate ester-based thermoplastic polyurethane, an ether-based thermoplastic polyurethane, a caprolactone-based thermoplastic polyurethane and a polycarbonate-based thermoplastic polyurethane.

10. The multilayered tubular shaped object according to claim 1, wherein an amount of the adhesive polyolefin contained in the interlayer is 75 mass % or more.

11. The multilayered tubular shaped object according to claim 1, wherein a softening temperature of the adhesive polyolefin is 120 to 185° C.

12. The multilayered tubular shaped object according to claim 1, wherein the adhesive polyolefin comprises a polyolefin having an aromatic ring on a side chain.

13. The multilayered tubular shaped object according to claim 12, wherein the adhesive polyolefin comprises a styrene grafted polyolefin and polystyrene.

14. The multilayered tubular shaped object according to claim 1, wherein the adhesive polyolefin comprises an ester containing group on a side chain.

15. The multilayered tubular shaped object according to claim 14, wherein the adhesive polyolefin comprises a maleic anhydride modified ethylene-vinyl acetate copolymer.

16. The multilayered tubular shaped object according to claim 1, wherein the thickness of the interlayer is 0.01 to 1.5 mm.

17. The multilayered tubular shaped object according to claim 1, wherein a maximum load in a compression bending test (span: 200 mm) for the multilayered tubular shaped object is 19 N or less.

18. The multilayered tubular shaped object according to claim 1, wherein an amount of deflection of the multilayered tubular shaped object is less than 40 mm in a test for measuring an amount of deflection (temperature: 100° C.).
